(19) United States
(12) Patent Application Publication
(10) Pub. No.: US 2010/0230211 A1
(43) Pub. Date: Sep. 16, 2010

(54) EVACUATION LADDER

(76) Inventors: Glenn Johansson, Hisings Backa (SE); Alf Hákansson, Torslanda (SE)

Correspondence Address: WRB-IP LLP, 801 N. Pitt Street, Suite 123, ALEXANDRIA, VA, 22314, US

(21) Appl. No.: 12/303,995

(22) PCT Filed: Jun. 29, 2006
(86) PCT No.: PCT/SE06/00805

§ 371 Date: Dec. 9, 2008

(51) Int. Cl. E06C 5/26; E06C 7/50

(52) U.S. Cl. 182/127

(57) ABSTRACT

A vehicle includes at least one driver seat and optionally at least one passenger seat, and an evacuation ladder for optional passengers and a driver, wherein the evacuation ladder makes it possible to exit the vehicle through a window or a door situated on an upper portion of the vehicle in a rolled-over position.

### BACKGROUND AND SUMMARY

The present invention relates to improvements regarding vehicle safety.

As is well known by persons skilled in the art of wide body vehicles (e.g. lorries, busses, construction machines, etc), the large width of such vehicles makes it very hard to evacuate the vehicle through the doors in a roll-over situation, i.e. a situation where the vehicle is resting on the side after an accident or a mishap, simply because the door facing the ground will be impossible to open, and the door facing the sky is situated high above the ground. Roll-over accidents are rather common, and it would be very beneficial if it should be easier to evacuate a rolled-over wide body vehicle.

In this context, it could also be worth mentioning the fact that a majority of the drivers and passengers of wide body vehicles are using seat belts. Seat belts are of course very beneficial from a safety point of view, but do also pose a problem in a roll-over situation,—either the passenger or the driver (which usually are seated on opposite sides of the vehicle) will end up hanging from the seat belt, rather high above the ground. When the driver and/or passenger release (s) the buckle of the seat belt, which by the way is necessary to get out, he or she will fall down to the opposite end of the vehicle,—the fall itself may inflict worse damages than the roll-over itself.

One possible escape route from a rolled-over wide body vehicle may be the windscreen; modern windscreens are, however, manufactured from very tough material, and there is a trend towards using windscreens glued to the cab of the vehicle. Gluing of the windscreen to the cab is more cost efficient and does also give more strength and stiffness to the cab, but also makes it more difficult to use the windscreen as an escape route. Some wide body vehicles are provided with a roof hatch or a sun roof; such vehicles are much easier to escape from in a rolled-over condition, but it is not always possible to provide e.g. a lorry cab with a roof hatch. Today, the driver and/or passenger must climb on the seats to escape a rolled-over vehicle without roof hatch. This includes not only hard manual labor, but also a severe risk of falling, which might inflict further injuries on the body, not to mention that it might be impossible for an injured person to execute a climbing on seats to reach a heavy door, which should be opened for allowing an escape from the vehicle.

In some seat designs, the armrests could be used as ladder steps that could be used to reach the top door, but usually the armrests are manufactured from a low-friction material in order not to wear the clothing arms. The low-friction properties of the armrests increase the risk of falling during the climbing. Moreover, most arm rests are articulated, so that they could be rotated up- and downwards, both to fit the driver or passenger, and for allowing easy entrance and exit to and from the seat, respectively. The articulation makes the armrests even less suitable for climbing.

EP-B-O 322 606 discloses a retractable step for enabling easy climbing to a bed located in an upper potion of a lorry cab. This patent does not in any way address the problem of enabling an exit rout from a rolled-over vehicle.

U.S. Pat. No. 4,556,125 describes a method for installing a pivotal ladder used for facilitating entering and exiting a vehicle. The method disclosed in U.S. Pat. No. 4,256,125 does not in any way hint on any solution facilitating emergency exiting from a rolled-over vehicle.

It is desirable to provide a means for facilitating emergency exit from a rolled-over wide body vehicle.

According to an aspect of the invention, an evacuation ladder for optional passengers and a driver is provided, wherein the evacuation ladder makes it possible to exit the vehicle through a window or a door situated on an upper portion of the vehicle in a rolled-over position. The invention is most beneficial if the vehicle where the evacuation ladder is mounted is a lorry or a bus.

In one embodiment of the invention, the evacuation ladder is a rope ladder, which could comprise two ropes or wires, which, on regular intervals, are interconnected by step portions. In one embodiment, the regular intervals could be about 30-50 cm. In order to save space and allow for a rapid activation process, the rope ladder could be stored in a rolled manner on a shelf, wherein the force of gravity will make the rope ladder fall from the shelf in case the vehicle would roll over.

The rope ladder embodiment is beneficial in that it is uncomplicated and inexpensive.

In another embodiment of the invention, the evacuation ladder comprises at least one ladder step, comprising a step portion attached to at least one stanchion, wherein the stanchions could be inserted into support pipes for allowing a telescopic function of the ladder step. The support pipes could be fastened to a base plate, which in turn could be fastened to a side surface of a seat suspension.

In order to have an automatic function of the ladder steps at least one pyrotechnical charge could be arranged in at least one of the support pipes or at least one of the stanchions, wherein said pyrotechnical charge is connected to a controller firing said pyrotechnical charge in the event of a roll-over. Combustion gases from the pyrotechnical charge will force the stanchions outwards from the support pipes.

### BRIEF DESCRIPTION OF THE DRAWINGS

In the following, the invention will be described with reference to the appended drawings, wherein:

FIG. 1 is a schematic side view showing a ladder step in a first embodiment of the present invention, wherein the ladder step is attached to a side of a seat, and wherein the ladder step is magnified in a separate bubble,

FIG. 2 is a schematic front view of a rolled-over wide body vehicle provided with the ladder steps of the first embodiment,

FIG. 3 is a schematic front view of a rolled-over wide body vehicle provided with ladder steps attached to a roof portion of the vehicle, and

FIG. 4 is a schematic front view of a rolled-over wide body vehicle provided with a rope ladder.

### DETAILED DESCRIPTION

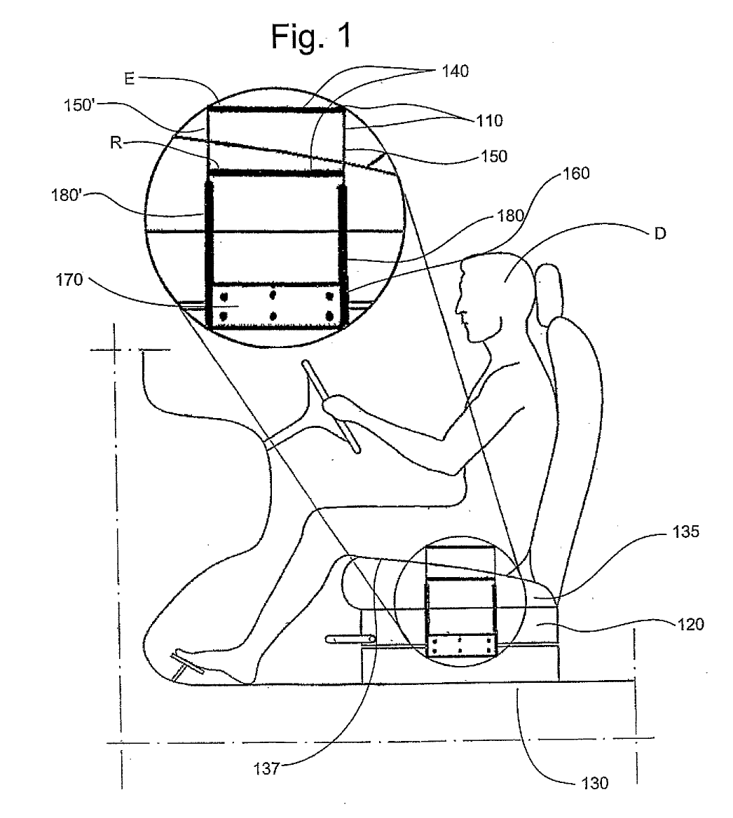

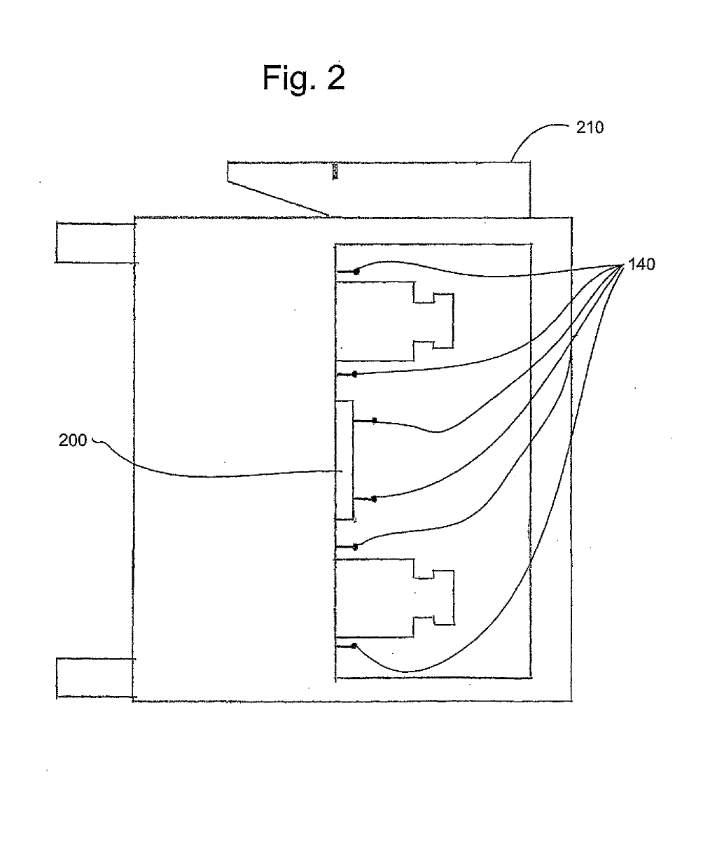

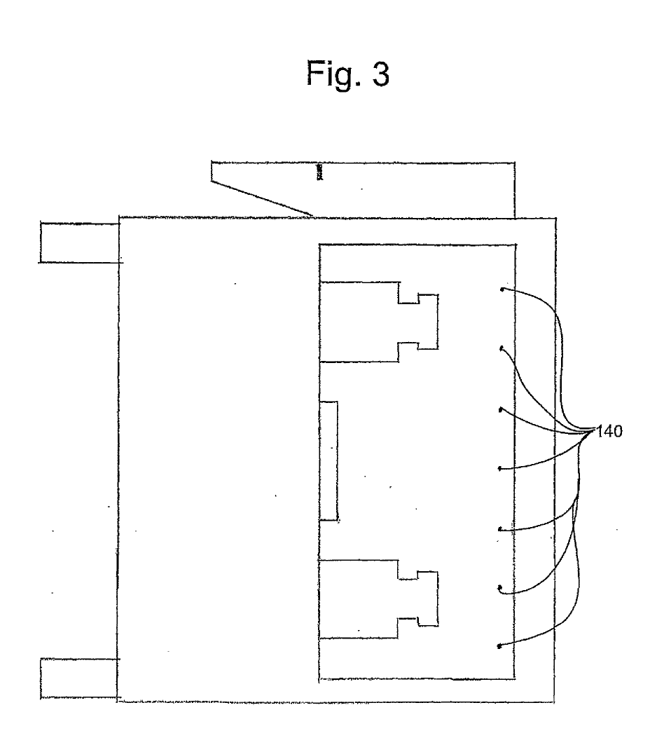

In FIG. 1, a ladder step 110 comprised in a first embodiment of an evacuation ladder 100 is shown. The ladder step 110 is fastened to a side surface 120 of a seat suspension 130, suspending a seat 135, and a seat surface 137, on which a driver D could be seated, and is provided with a telescopic_function allowing the ladder step to assume a first retraced position (shown by R) and one extended position (shown by E). Preferably, such ladder steps are provided on both lateral sides of the seat 135, and optionally on sides of an engine compartment (shown in FIGS. 2-3 by 200), in order to provide a convenient and safe escape route from a rolled-over vehicle. The ladder step 110 comprises a step portion 140, comprising first and second ends, wherein the ends are suspended on two stanchions 150, 150′. Moreover, the ladder step 110 comprises a base portion 160, which includes a base plate 170 and two support pipes 180, 180′ The support pipes 180, 180′ are fastened to the base portion 160 in a parallel relationship and at a distance from one another that is equal to the distance between the first and second ends of the step portion 140.

Preferably, the inner diameter of the support pipes 180, 180′ is slightly larger than the outer diameter of the two stanchions 150, 150′. This diameter relationship, and the fact that support pipes and the stanchions are arranged in a parallel relationship with equal distances, makes it possible to insert the stanchions into the support pipes. A telescopic function then achieved.

In a preferred—embodiment of the invention, the support pipes 180, 180 extend “upwards”, i.e. towards the seating surface 137 of the seat 136, to a height where the upper ends of the support pipes do not interfere with the driver D, neither during normal seating in the seat nor during entering and leaving the seat.

As mentioned earlier, the stanchions 150; 150′ are designed to be inserted into the support pipes 180, 180′. The step portion 140 limits the amount of insertion, such that the step portion will limit the stanchions' insertion into the support pipes as the step portion engages the support pipes 180, 180′.

As could be understood by persons skilled in the art, it is possible to pull the stanchions out from the support pipes, e.g. by grabbing the step portion and pull the step portion upwards, i.e. in a direction opposite the direction used to insert the stanchions into the support pipes. In one embodiment of the invention, there is provided a locking function as the step portion is fully extended. Such locking function could e.g. be obtained by providing a spring loaded pin (not shown) extending outwards from an opening (not shown) in either or both of the stanchions 150, 150′. As the stanchions are fully or partly inserted into the support pipes 180, 180′, the spring loaded pins will urge against the inner surface of the support pipes,—however, at a position where the stanchions are regarded as fully extended, there might be an opening provided in the support pipes, in which opening the spring loaded pin will “pop” out, hence locking the stanchion in that position as compared to the support pipe. In the locked position, the step portion is preferably in a position allowing climbing up to the upward facing door of a rolled-over vehicle.

The embodiment described above requires manual operation of the step portion 140; it might, however, be preferred to provide the ladder step 110 according to the invention with an automatic release function, e.g. by providing the support pipes with some kind of pyrotechnical device connected to a controller receiving input on the position of the vehicle; if the controller would receive information corresponding to a rolled-over position of he vehicle, it would fire the pyrotechnical device. Gases from the combustion of the pyrotechnical device would then force the stanchions into an extended position, where the stanchions could be locked using the aforementioned spring-loaded pin/opening device.

In another embodiment, the ladder step 110 could be pneumatically operated; as is well known by persons skilled in the art of heavy vehicles, there is often a reservoir of pressurized air located onboard the vehicle. This pressurized air could be used to push the stanchions 150, 150′ out from the support pipes 180, 180′ in a similar way as the gases from the pyrotechnical device force the stanchions 150, 150′ out from the support pipes 180, 180′. Locking of the stanchions 150, 150′ can be arranged by the aforementioned spring-loaded pin/opening device.

Preferably, the activation of the stanchion ejection is controlled by a controller controlling a single air valve connecting each support pipe 180, 180′, by a hosing or piping, to the reservoir for pressurized air in case the controller senses a rolled-over position for the vehicle.

For both the solution comprising a pyrotechnical charge, and the solution with pressurized air, it is possible to control activation of the ladder by a manual button or handle connected to the pyrotechnical charges or the system containing pressurized air.

As mentioned earlier, the ladder steps 110 according to the invention are preferably fastened to the side surfaces 120 of the seat suspensions 130. As is well known by persons skilled in the art, there are usually two seats provided in a wide body vehicle, one for the driver D and one for a passenger (not shown). FIG. 2 shows how the step portions 140 will form a ladder enabling climbing from a low position of the wide body vehicle to a door 210 facing upwards. When at the door, it is possible to open the door, or a side window, in order to escape the vehicle. As can be seen in FIG. 2, there are ladder steps provided not only at the side surfaces of the seats, but also at the engine compartment 200; this might, depending on the width of the vehicle, be unnecessary. In another embodiment of the invention, shown in FIG. 3, the step portions 140 (and its corresponding stanchions and support pipes) are mounted in the ceiling of the vehicle. This might be advantageous in some vehicle designs, and facilitates, in some cases, exiting from the side window of the vehicle.

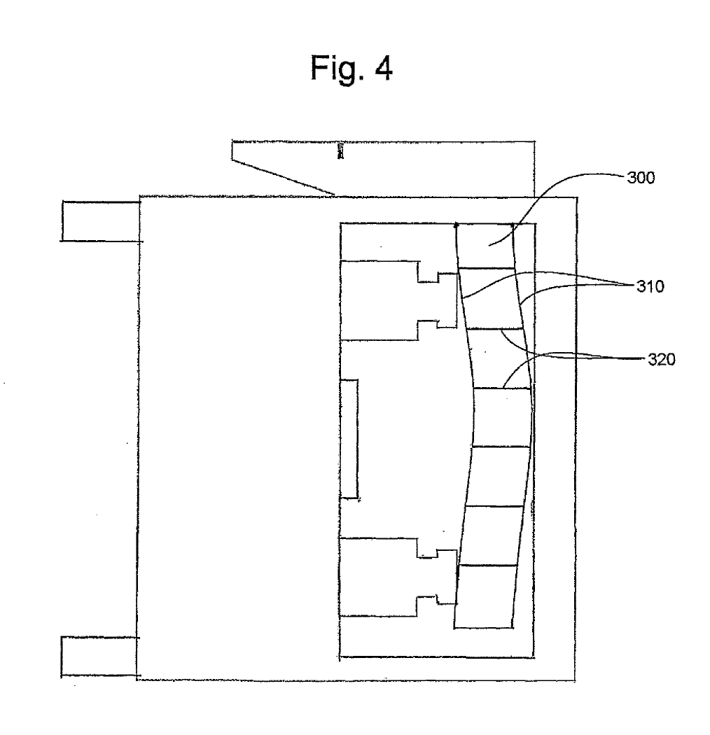

In still a further embodiment, shown in FIG. 4, a rope ladder 300, comprising two ropes 310 interconnected at even intervals (e.g. every 30-50 cm) by step portions 320, hangs from the side of the vehicle facing upwards; the rope ladder is preferably folded during normal operation of the vehicle, and is unfolded in the event of a roll-over. The unfolding could be obtained in a number of ways, wherein a preferable way is to “roll” the ropes and step portions 320 around the step portion situated the longest way from the point where the rope ladder is hung, and thereafter store the roll on a shelf (not shown); in case of a roll-over, the roll will fall from the shelf, and, due to gravity, unroll to enable exit of the vehicle through the door facing upwards in a roll-over situation. In order to provide for exit routes regardless of rollover direction, there could be provided shelves with rolled rope ladders on both shelves.

To avoid that the rolled rope ladders 300 fall from their shelves during normal operation of the vehicle, there might be a ridge provided near the end of the shelf facing the interior spaces of the vehicle.

The embodiment comprising a rope ladder is also beneficial in that the rope ladder presents a convenient escape route down from the side of a rolled-over vehicle to the ground. This escape route is enabled if the person having escaped the interior of the rolled over vehicle, and stands on top of the vehicle grabs the rope ladder he or she just used, and hangs it from the vehicle towards the ground. Obviously, there are a number of modifications possible within the scope of the invention, such as it is defined in the appended claim set. For example, the release mechanisms could be designed in other ways than described. Moreover, the ladder steps have been described as being placed to enable exit through a vehicle door or its side window. For e.g. buses, it might be suitable to arrange a ladder system according to the invention near the positions where emergency hammers (which often are provided at windows adapted to be broken by said hammer in case of an emergency exit) are placed. Such an arrangement would firstly significantly increase the possibility to reach the hammer and break the window, and secondly provide an exit route, through the window, for person's stuck inside the vehicle. In conclusion, the ladder according to the invention is a step towards a higher security level for wide-body vehicles, not only since the ladder according to the invention facilitates exiting of the vehicle, but also since it provides a means for avoiding falling through the vehicle as a bucket of a seat belt is released by the driver or a passenger hanging in said seat belt; he or she could grab e.g. a ladder step by hand, prior to releasing the buckle with the other hand.

As could be understood, there are many modifications, alterations, and changes possible within the invention such as it is defined in the appended claims.

1. Vehicle, comprising at least one driver seat and an evacuation ladder wherein the evacuation ladder makes it possible to exit the vehicle through a window or a door situated on an upper portion of the vehicle in a rolled-over position,
the evacuation ladder comprising at least one ladder step with a step portion attached to at least one stanchion wherein the at least one stanchion could be inserted into support pipes for allowing a telescopic function of the ladder step, and
that at least one pyrotechnical charge being arranged in at least one of the support pipes or at least one of the stanchions wherein said pyrotechnical charge is connected to a controller firing said pyrotechnical charge in the event of a roll-over.

2. The vehicle of claim 1, wherein the vehicle is a lorry or bus.

3. The vehicle of claim 1, wherein the evacuation ladder comprises a rope ladder.

4. The vehicle of claim 3, wherein the rope ladder comprises two ropes or wires, which, on regular intervals, are interconnected by step portions.

5. The vehicle of claim 4, wherein the regular intervals span 30-50 cm.

6. The vehicle of claim 5, wherein the rope ladder is stored in a rolled manner on a shelf, wherein the force of gravity will make the rope ladder fall from the shelf in case the vehicle would rollover.

7. The vehicle of claim 6, wherein the support pipes are fastened to a base plate.

8. The vehicle of claim 7, wherein the ladder step is fastened to a side surface of a seat suspension.

9. The vehicle of claim 2, wherein the evacuation ladder comprises a rope ladder.

10. The vehicle of claim 9, wherein the rope ladder comprises two ropes or wires, which, on regular intervals, are interconnected by step portions.

11. The vehicle of claim 9, wherein the rope ladder is stored in a rolled manner on a shelf, wherein the force of gravity will make the rope ladder fall from the shelf in case the vehicle would rollover.

12. The vehicle of claim 11, wherein the support pipes are fastened to a base plate.

13. The vehicle of claim 12, wherein the ladder step is fastened to a side surface of a seat suspension.

14. The vehicle of claim 1, wherein the support pipes are fastened to a base plate.

15. The vehicle of claim 1, wherein the ladder step is fastened to a side surface of a seat suspension.
